(19) United States
(12) Patent Application Publication
(10) Pub. No.: US 2026/0244240 A1
(43) Pub. Date: Aug. 20, 2026

(54) Method for Providing Clock Signal in Data Path, and Apparatus

(71) Applicant: SANECHIPS TECHNOLOGY CO., LTD., Shenzhen (CN)

(72) Inventor: Xiaoge ZHU, Shenzhen (CN)

(21) Appl. No.: 19/159,439

(22) PCT Filed: Jan. 15, 2024
(86) PCT No.: PCT/CN2024/072373

§ 371 Date: Aug. 25, 2025

(30) Foreign Application Priority Data
Mar. 31, 2023 (CN) 202310363652.0

(51) Int. Cl. G06F 1/12

(52) U.S. Cl. CPC G06F 1/12

(57) ABSTRACT

A method for providing a clock signal in a data link includes: in each clock domain among a plurality of clock domains of a data link, generating a reset pulse signal on the basis of an input synchronization reference signal and an input clock signal, generating an output synchronization reference signal on the basis of the input synchronization reference signal and the input clock signal, and generating an output clock signal on the basis of the input clock signal; and, by means of the reset pulse signal, resetting the output synchronization reference signal and the output clock signal, and synchronously generating a reset output synchronization reference signal and a reset output clock signal at the next rising edge of the input clock signal after the reset pulse signal ends.

### CROSS-REFERENCE TO RELATED APPLICATION

The present disclosure is a National Stage Filing of the PCT International Application No. PCT/CN2024/072373 filed on Jan. 15, 2024, which is based on and claims priority to Chinese Patent Application CN2023103636520 filed on Mar. 31, 2023 and entitled “Method for Providing Clock Signal in Data Path, and Apparatus”, the disclosure of which is incorporated herein by reference in its entirety.

### TECHNICAL FIELD

Embodiments of the present disclosure relate to the field of communications, and in particular, to a method for providing a clock signal in a data path, and an apparatus.

### BACKGROUND

In recent years, the rapid development of the Fifth Generation (5G) communication, along with technologies such as a large-scale antenna technology (e.g., massive Multiple-Input Multiple-Output (MIMO)) and Global Positioning System Pulse Per Second (GPS 1PPS) timing, has increased system capacity and clock precision, which in turn has raised higher requirements for the precision of data path delays in baseband and Radio Frequency (RF) transceiver systems. The present disclosure will illustrate with high-speed and high-precision as an example. High-speed and high-precision are crucial components of the RF transceiver system, and the delay precision of these components is very important for the overall system delay precision.

Traditional methods for clock phase initialization in multiple clock domains use the mechanism of asynchronous reset and synchronous release to give the reset signal a clear release sequence, which is able to reduce metastability issues caused by the release of the reset signal and effectively capture the reset. When adopting these traditional methods, even if the reset pulse is relatively narrow, the reset function will not be lost. However, there are several problems discussed as follows. First, if the scale of the circuit is large and different clock domains are far away from each other, it will cause a large load on the reset signal. To ensure signal quality of the reset signal, a large number of buffer circuits are needed. In this case, the delay of the reset signal transmitted to different clock domains will change greatly with the changes of process voltage temperature (PVT), thus affecting the timing precision of the reset signal arriving at each clock domain. Second, there is uncertainty of the delay between different clock domains. Third, there are still metastability issues during the release of the reset, and metastability will seriously affect the timing precision of the reset signal, thereby affecting the precision of the delay of the reset signal.

For the uncertainty of delay between different clock domains in related technologies, no solution has been proposed yet.

### SUMMARY

The embodiments of the present disclosure provide a method for providing a clock signal in a data path, and an apparatus, which may at least solve the problems of heavy load and desynchronization of a reset signal due to uncertainty of time delays among different clock domains, and the problems that a metastable state still exists when the reset is released in the related art.

According to at least one embodiment of the present disclosure, there is provided a method for providing a clock signal in a data path. The method includes:
in each clock domain of a plurality of clock domains of the data path, generating a reset pulse signal based on an input synchronization reference signal and an input clock signal, generating an output synchronization reference signal based on the input synchronization reference signal and the input clock signal, and generating an output clock signal based on the input clock signal; and
resetting the output synchronization reference signal and the output clock signal by the reset pulse signal, and synchronously generating a post-reset output synchronization reference signal and a post-reset output clock signal at a next rising edge of the input clock signal after the reset pulse signal ends, wherein the post-reset output synchronization reference signal and the post-reset output clock signal are transmitted to a next clock domain of the data path with a same time delay, as the input synchronization reference signal and the input clock signal for the next clock domain.

According to another embodiment of the present disclosure, there is provided an apparatus for providing a clock signal in a data path. The apparatus includes: a reset pulse signal generation circuit, an output synchronization reference signal generation circuit, and an output clock signal generation circuit, wherein
the reset pulse signal generation circuit is used, in each clock domain of a plurality of clock domains of the data path, for generating a reset pulse signal based on an input synchronization reference signal and an input clock signal, generating an output synchronization reference signal based on the input synchronization reference signal and the input clock signal, and generating an output clock signal based on the input clock signal; and the reset pulse signal generation circuit is used for inputting the reset pulse signal to the output synchronization reference signal generation circuit and the output clock signal generation circuit, so as to reset the output synchronization reference signal and the output clock signal;
the output synchronization reference signal generation circuit is used for synchronously generating a post-reset output synchronization reference signal at a next rising edge of the input clock signal after the reset pulse signal ends; and
the output clock signal generation circuit is used for synchronously generating a post-reset output clock signal at the next rising edge of the input clock signal after the reset pulse signal ends, wherein the post-reset output synchronization reference signal and the post-reset output clock signal are transmitted to a next clock domain of the data path with a same time delay, as the input synchronization reference signal and the input clock signal for the next clock domain.

According to still another embodiment of the present disclosure, there is provided a computer readable storage medium. The storage medium stores a computer program, wherein the computer program, when running on a processor, causes the processor to execute the operations in any one of the method embodiments.

According to yet another embodiment of the present disclosure, there is provided an electronic device, including a memory and a processor, wherein the memory stores a computer program, and the processor is configured to run the computer program so as to execute the operations in any one of the method embodiments.

### BRIEF DESCRIPTION OF THE DRAWINGS

FIG. 1 is a system block diagram of a digital-to-analog converter in the related art;

FIG. 2 is a flowchart of a method for providing a clock signal in a data path according to at least one embodiment of the present disclosure;

FIG. 3 is a timing diagram of high-precision time delay according to at least one embodiment of the present disclosure;

FIG. 4 is a first circuit diagram of high-precision time delay according to at least one embodiment of the present disclosure;

FIG. 5 is a first schematic diagram of clock frequency deviation compensation according to at least one embodiment of the present disclosure;

FIG. 6 is a circuit diagram of a buffer according to at least one embodiment of the present disclosure;

FIG. 7 is a first circuit diagram of multi-phase clock generation according to at least one embodiment of the present disclosure;

FIG. 8 is a second circuit diagram of multi-phase clock generation according to at least one embodiment of the present disclosure;

FIG. 9 is a first circuit diagram of reset pulse generation according to at least one embodiment of the present disclosure;

FIG. 10 is a second circuit diagram of reset pulse generation according to at least one embodiment of the present disclosure;

FIG. 11 is a second schematic diagram of clock frequency deviation compensation according to at least one embodiment of the present disclosure;

FIG. 12 is a second circuit diagram of high-precision time delay according to at least one embodiment of the present disclosure;

FIG. 13 is a third circuit diagram of high-precision time delay according to at least one embodiment of the present disclosure; and

FIG. 14 is a block diagram of an apparatus for providing a clock signal in a data path according to at least one embodiment of the present disclosure.

### DETAILED DESCRIPTION OF THE EMBODIMENTS

Embodiments of the present disclosure will be described below in detail with reference to the accompanying drawings and in conjunction with embodiments.

It should be noted that, terms such as “first” and “second” in the description, claims, and accompanying drawings of the present disclosure are used to distinguish similar objects, but are not necessarily used to describe a specific sequence or order.

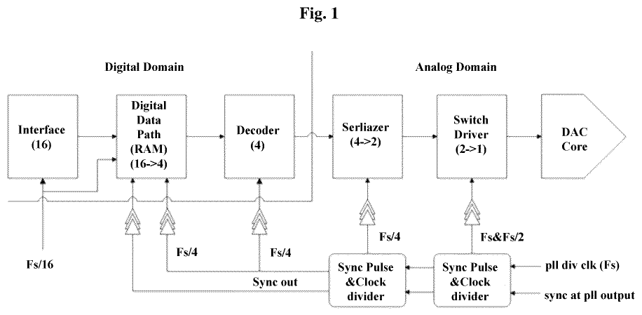

FIG. 1 is a system block diagram of a Digital-to-Analog Converter (DAC) in the related art. As shown in FIG. 1, the DAC includes a data path (Data Path), a clock path (CLK Path), and a DAC core circuit (DAC Core). The data path includes an interface circuit (Interface), a digital data path (Digital Data Path), a decoder (Decoder), a serializer (Serializer), and a switch driver (Switch Driver). The clock path includes a synchronization pulse circuit (Clock Receiver), a clock divider (Clock Divider), and a driver, etc. The DAC core circuit includes a plurality of DAC core slices (DAC Core Slices). In the interface circuit, 16 channels of low-speed data operate at a frequency of Fs/16 and are transmitted in parallel to the digital data path. The digital data path is mainly composed of four random access memories (RAMs). The 16 channels of data are divided into four groups and written into the four RAMs under the clock of Fs/16. Four phases of the clock with a frequency of Fs/4 control to read out four channels of data from the four RAMs, which are then input into the decoder. After the decoder completes the code conversion, the serializer combines the 4-phase data into 2-phase data using double-edge sampling, and then the switch driver combines the 2-phase data into 1-phase data. Throughout the parallel-to-serial conversion process, modules in different data paths operate under different clock frequencies, and even within the same module, the clock phases of multiple data channels are different. Ultimately, data transmission and sending are completed under the control of multiple clock domains. Therefore, the precision of clock frequency and clock phase in different clock domains determines the timing precision of the data path.

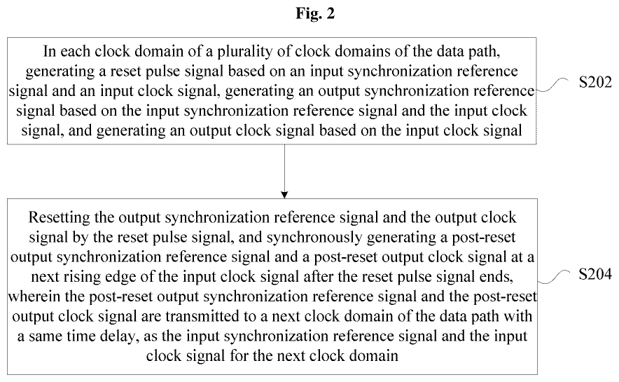

The present embodiment provides a method for providing a clock signal in a data path. FIG. 2 is a flowchart of a method for providing a clock signal in a data path according to at least one embodiment of the present disclosure. As shown in FIG. 2, the flow includes the following operations S202 to S204.

In operation S202, in each clock domain of a plurality of clock domains of the data path, a reset pulse signal is generated based on an input synchronization reference signal and an input clock signal, an output synchronization reference signal is generated based on the input synchronization reference signal and the input clock signal, and an output clock signal is generated based on the input clock signal.

In at least one embodiment of the present disclosure, the reset pulse signal is a pulse signal with a preset width, and the preset width may be flexibly set according to actual requirements.

In operation S204, the output synchronization reference signal and the output clock signal are reset by the reset pulse signal, and a post-reset output synchronization reference signal and a post-reset output clock signal are synchronously generated at a next rising edge of the input clock signal after the reset pulse signal ends, wherein the post-reset output synchronization reference signal and the post-reset output clock signal are transmitted to a next clock domain of the data path with a same time delay, as the input synchronization reference signal and the input clock signal for the next clock domain.

The operations S202 to S204 address the issues in the related art where the heavy load on the reset signal and the inconsistency in transmission paths lead to uncertainties in timing delays among different clock domains, thereby causing problems such as desynchronization (misalignment) and metastability. Since each clock domain adopts a sequential synchronization approach, it ensures clear phase information for each clock domain, reducing the load on the synchronization reference signal and thereby decreasing the uncertainty of delays between different clock domains. By transmitting clock signals and synchronization reference signals together, the method avoids desynchronization (misalignment) issues and reduces the likelihood of metastability.

In at least one embodiment of the present disclosure, the operation S202 may include: generating the reset pulse signal when a rising edge of the input synchronization reference signal is detected at a rising edge of the input clock signal.

In an embodiment, the operation S204 may include: converting the output synchronization reference signal from a high level to a low level based on the reset pulse signal, and converting the output clock signal from a high level to a low level based on the reset pulse signal, so as to reset the output synchronization reference signal and the output clock signal; and synchronously generating the post-reset output synchronization reference signal and the post-reset output clock signal upon the arrival of the next rising edge of the input clock signal. The implementation is merely an exemplary embodiment, and the resetting may also be resetting from a low level to a high level.

In another embodiment, in the above operation S204, generating the post-reset output clock signal may include: generating a single-phase post-reset output clock signal according to the reset pulse signal and the input clock signal; or generating a multi-phase post-reset output clock signal according to the reset pulse signal and the input clock signal.

The foregoing operation S204 may specifically be executed by an output synchronization reference signal generation circuit and an output clock signal generation circuit. In a case where the output synchronization reference signal generation circuit includes a first D type Flip-Flop (DFF), the post-reset output synchronization reference signal is synchronously generated according to the reset pulse signal, the input synchronization reference signal and the input clock signal through the first DFF at the next rising edge of the input clock signal after the reset pulse signal ends. When the rising edge of the clock signal in the first DFF arrives, the output synchronization reference signal becomes the input synchronization reference signal; and when the low level of the clock signal arrives, the output synchronization reference signal keeps unchanged.

The output clock signal generation circuit is a single-phase clock generation circuit or a multi-phase clock generation circuit. In a case where the output clock signal generation circuit is the single-phase clock generation circuit, by means of the single-phase clock generation circuit, a single-phase post-reset output clock signal is synchronously generated according to the reset pulse signal and the input clock signal at the next rising edge of the input clock signal after the reset pulse signal ends. In a case where the single-phase clock generation circuit includes a third DFF, a single-phase post-reset output clock signal is synchronously generated according to the reset pulse signal and the input clock signal by the third DFF at the next rising edge of the input clock signal after the reset pulse signal ends.

In a case where the output clock signal is a multi-phase clock generation circuit, a multi-phase post-reset output clock signal is synchronously generated according to the reset pulse signal and the input clock signal through the multi-phase clock generation circuit at the next rising edge of the input clock signal after the reset pulse signal ends. In a case where the multi-phase clock generation circuit includes a divider (Divider) and a shift register (Shift register), the Divider generates a single-phase divided clock according to the input clock signal and the reset pulse signal at the next rising edge of the input clock signal after the reset pulse signal ends; and the Shift register generates a multi-phase post-reset output clock signal according to the single-phase divided clock generated by the Divider under the control of the input clock signal. In a case where the multi-phase clock generation circuit includes a state machine and a synchronization circuit, the state machine generates a multi-phase divided clock according to the input clock signal and the reset pulse signal at the next rising edge of the input clock signal after the reset pulse signal ends; and the synchronization circuit synchronizes the multi-phase divided clock, and outputs the multi-phase post-reset output clock signal.

In an exemplary embodiment, after the operation S204, the method further includes: synchronizing the post-reset output synchronization reference signal according to the post-reset output clock signal to obtain a new post-reset output synchronization reference signal. In this case, the described output synchronization reference signal generation circuit further includes a second DFF, wherein the second DFF is connected to the first DFF, and synchronizes the post-reset output synchronization reference signal according to the post-reset output clock signal so as to obtain the new post-reset output synchronization reference signal.

In at least one embodiment of the present disclosure, the above operation S202 may specifically include: generating, by using a reset pulse generation mode of a delayed signal, the reset pulse signal based on the input synchronization reference signal and the input clock signal; or generating, by using a reset pulse generation mode of a two-phase non-overlapping signal, the reset pulse signal based on the input synchronization reference signal and the input clock signal.

In another exemplary embodiment, the method further includes: in a case where a reset pulse enable signal is enabled and a new radio enable signal is enabled, generating the reset pulse signal based on the input synchronization reference signal and the input clock signal; and in a case where the reset pulse enable signal is enabled and the new radio enable signal is enabled, synchronously resetting the output synchronization reference signal and the output clock signal by the reset pulse signal. Further, in a case where the reset pulse enable signal is enabled and the new radio enable signal is not enabled, the output synchronization reference signal and the output clock signal are not reset; in a case where the reset pulse enable signal is not enabled and the new radio enable signal is enabled, the output synchronization reference signal and the output clock signal are not reset, and the output synchronization reference signal and the output clock signal are generated when the rising edge of the input clock signal arrives.

In at least one embodiment of the present disclosure, the input synchronization reference signal enters the reset pulse signal generation circuit and the output synchronization reference signal generation circuit respectively through the first buffer, the input clock signal enters the reset pulse signal generation circuit, the output synchronization reference signal generation circuit and the output clock signal generation circuit respectively through the second buffer, wherein the first buffer and the second buffer are structured as a chain of inverters, or the first buffer and the second buffer are integrated with a delay adjustment circuit, or the first buffer and the second buffer are integrated with a duty cycle adjustment circuit.

In at least one embodiment of the present disclosure,, the time delay on the data path may further be compensated in the following two manners. In a first manner, the input clock signal is counted in a period of the input synchronization reference signal of the plurality of clock domains, so as to obtain a counting result; the counting result is compared with a preset counting result to obtain a first comparison result; a first clock frequency deviation of a target time delay is determined according to the first comparison result; and a time delay of the data path is adjusted by adjusting an address of read data, so as to compensate for the first clock frequency deviation of the target time delay, thereby realizing the compensation for the time delay on the data path. In a second manner, a current address upon arrival of a rising edge of the input synchronization reference signal is acquired; the current address is compared with an initialization address to obtain a second comparison result; a second clock frequency deviation of a target time delay is determined according to the second comparison result; and a time delay of the data path is adjusted by adjusting a position of a read address in a random access memory, so as to compensate for the second clock frequency deviation of the target time delay, wherein a storage depth of the random access memory is a product of a ratio of a period of the input synchronization reference signal to a period of a read signal, and an inverse of N, thereby compensating for the first clock frequency deviation of the target time delay, and realizing compensation for the time delay on the data path by adjusting the position of the read address in the random access memory. The target time delay is a time from a start of resetting the output synchronization reference signal and the output clock signal to the synchronously generating the post-reset output synchronization reference signal and the post-reset output clock signal.

The embodiments of the present disclosure introduce an input synchronization reference signal, which can be either a periodic signal or a step signal. By generating a reset pulse signal utilizing the input synchronization reference signal and the input clock signal based on synchronous sequential logic, the reset pulse signal is given a clear time delay characteristic (i.e., the time delay characteristic is definite). Then, cables for generation of the multi-phase output clock signal and cables for generation of the output synchronization reference signal are reset and synchronized, making the multi-phase output clock signals have definite phase information (i.e., the phase information is certain), and the multi-phase output clock signal and the output synchronization reference signal are transmitted together to the next clock domain to repeat the above operations. Since each clock domain is synchronized in sequence, the load on the synchronization reference signal is reduced, thereby decreasing the uncertainty of its time delay across different clock domains. By transmitting the clock signal and the synchronization reference signal together, the issue of misalignment is avoided, and the probability of metastability is reduced. In this way, each clock domain has explicit phase information (i.e., the phase information is definite/certain). When the synchronization reference signal is a periodic signal, its period is an integer multiple of the ideal clock frequency. Within the period of the synchronization reference signal, the clock signal is counted, and the count result is compared with the ideal count result to determine the deviation in clock frequency, and the time delay of the data path is adjusted by adjusting the address of the read data to compensate for the time delay deviation. This method ensures that the entire data transmission link has stable clock phase information and achieves precise time delay characteristics by timely compensating for the time delay deviations caused by clock frequency variations.

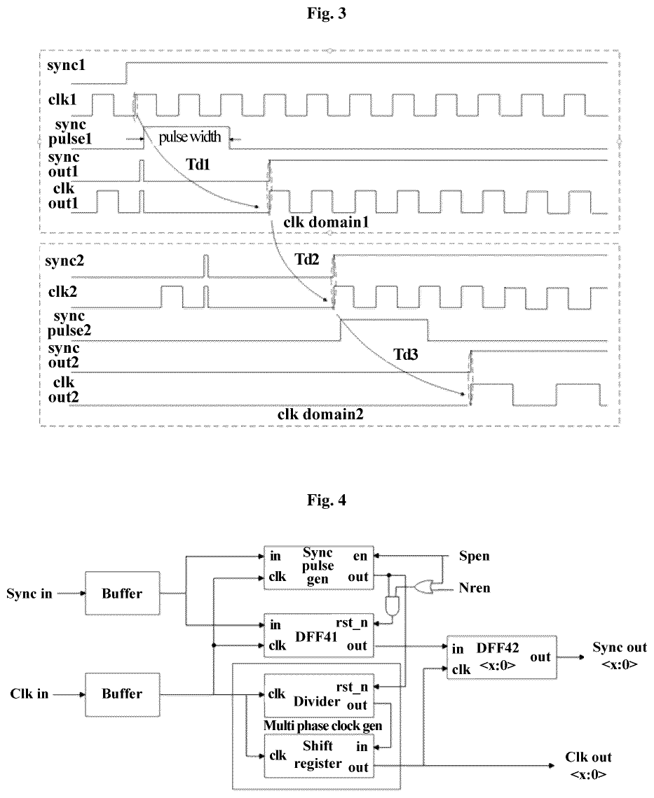

FIG. 3 is a timing diagram of high-precision time delay according to at least one embodiment of the present disclosure. As shown in FIG. 3, the upper five signals are in Clock Domain 1 (clk domain1), and the lower five signals are in Clock Domain 2 (clk domain2). FIG. 3 involves the process of generating reset pulses (sync pulse1/2), multi-phase divided clocks (Clk out1/2), and output synchronization reference signals (Sync out1/2) locally from synchronization reference signals (syncin1/2) and local clocks (Clk in1/2), as well as the transmission process of synchronization reference signals and clock signals between different clock domains (Clk out1 becomes Clk in2 after being delayed, and Sync out1 becomes sync in2 after being delayed). The reset pulse signals, multi-phase divided clocks, and output synchronization reference signals are all generated synchronously under the control of local clock signals, with clear and stable timing and precise delay information. As shown in FIG. 3, after clk1 captures sync in1, a rising edge of sync pulse1 is generated, then Sync out1 and Clk out1 are reset, and after two cycles of clk1, a falling edge of sync pulsel is generated. At the next rising edge of clk1, the Clk out1 and Sync out1 after the reset (i.e., the Clk out1 and Sync out1 are post-reset Clk out1 and post-reset Sync out1) are generated, so that after three cycles of clk1 (this time period is denoted as Td1) after capturing sync in1, clk1 generates a new clock signal Clk out1 and a synchronization signal Sync out1. Since the synchronization reference signal (Sync out1) and the output clock (Clk out1) are transmitted together to the next clock domain. By ensuring that the synchronization reference signal (Sync out1) and the output clock (Clk out1) have identical transmission paths (i.e., their transmission paths match each other), it can be ensured that when the synchronization reference signal and the clock signal arrive at the next clock domain (clk domain2), they (serving as sync in2 and Clk in2) still have a clear phase relationship and delay information Td2. In Clock Domain 2, the same process is followed for resetting the multi-phase clock (Clk out2) and transmitting the clock signal and the synchronization reference signal (Sync out2), consistent with the process in Clock Domain 1. After three cycles of Clk in1 (this time period is denoted as Td3) after Clk in2 captures sync in1, Clk in2 generates a clock signal Clk out2 and a synchronization signal Sync out2 after the reset. After the synchronization reference signal has been transmitted to all clock domains, all clock resets are completed, ensuring that the clock signals in each clock domain have a definite delay relative to the synchronization reference signal, and thus the clock signals also have a definite delay relative to each other. As shown in FIG. 3, considering the case of two clock domains, Clk1 out is delayed by three cycles of Clk in1 relative to sync in1, and Clk2 out is delayed by three cycles of Clk in2 plus a transmission delay Td2 between the clock domain 1 and clock domain 2. Since the delay of Td2 in the cable is relatively stable and can be considered a fixed delay, Clk out2 also has a fixed delay relative to sync in1.

FIG. 4 is a first circuit diagram of high-precision time delay according to at least one embodiment of the present disclosure. As shown in FIG. 4, the input synchronization reference signal (Sync in) and the local input clock signal (Clk in) pass through a buffer circuit (Buffer) to reach the local clock domain, where circuits are applied to generate a reset pulse signal (sync pulse), an output synchronization reference signal (Sync out<x:0>), and an output clock signal (Clk out<x:0>). These signals are all generated under the synchronized sequential logic of the local clock signal (Clk in). The reset pulse signal (sync pulse) is generated using the synchronization reference signal (Sync out) and the input clock signal (Clk in), with a built-in pulse width adjustment function that outputs a pulse width that is an integer multiple of the period of the input clock signal (Clk in). The reset pulse signal is applied to an output synchronization reference signal generation circuit and an output clock signal generation circuit, wherein the output clock signal generation circuit specifically includes DFF41 (corresponding to the aforementioned first DFF) and DFF42 (corresponding to the aforementioned second DFF), to reset the output synchronization reference signal and the output pulse signal, thereby obtaining the post-reset output synchronization reference signal and the post-reset output pulse signal. After the reset pulse signal ends, when the next rising edge of the local clock arrives, a new output clock signal and a new output synchronization reference signal with a clear phase relationship are generated. The multi-phase output clock signal may be generated in various ways. FIG. 4 shows a scheme where a single-phase divided clock is first generated through a Divider, and then a multi-phase clock (Clk out<x:0>) is generated through a Shift register. To ensure the phase relationship between the multi-phase output clock signal and the output synchronization reference signal, the output synchronization reference signal is synchronized by the multi-phase output clock (DFF<x:0>), so as to a multi-phase output synchronization reference signal (Sync out<x:0>). Additionally, the circuit integrates a reset pulse enable signal (sync pulse en, abbreviated as Spen) and a new radio enable signal (new radio en, abbreviated as Nren). When the reset pulse signal is enabled, the reset pulse signal is normally generated, so as to reset the output synchronization reference signal and the output clock signal. When the reset pulse enable signal is not enabled and the new radio signal is enabled, the output synchronization reference signal and the output clock signal are not reset, and the synchronization reference signal is synchronously transmitted to the next clock domain through the local clock.

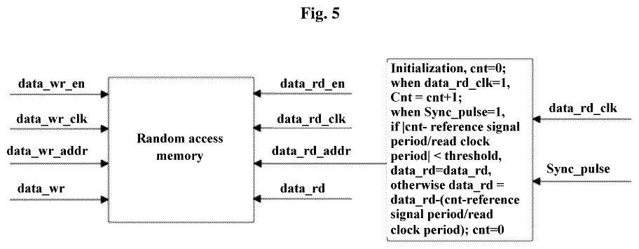

The synchronization reference signal may be either a single rising-edge step signal or a periodic signal. When the synchronization reference signal is a step signal, the synchronization reference signal is often used for clock phase reset and the initialization of the read address in the random access memory. When the synchronization reference signal is a periodic signal, in addition to resetting and initializing, the synchronization reference signal may be used to correct the timing errors caused by frequency errors in the divided clock signals. When the synchronization reference signal is a periodic signal, it is suggested to ensure that the period of the synchronization reference signal is an integer multiple of the ideal clock frequency. FIG. 5 is a first schematic diagram of clock frequency deviation compensation according to at least one embodiment of the present disclosure. As shown in FIG. 5, to correct timing deviations, a data buffer is introduced into the digital data path of the data path. By periodically counting the divided clock signal and comparing the count result with the ideal count result, the precision of the divided clock frequency is determined, and the deviation of the clock frequency is corrected by adjusting the data timing. To avoid frequent updates to the read address position, a threshold is also set. If the deviation is within the threshold range, the read address is not updated; if the deviation exceeds the threshold, the read address is updated to the expected position, thereby ensuring that the delay deviation is within the required range.

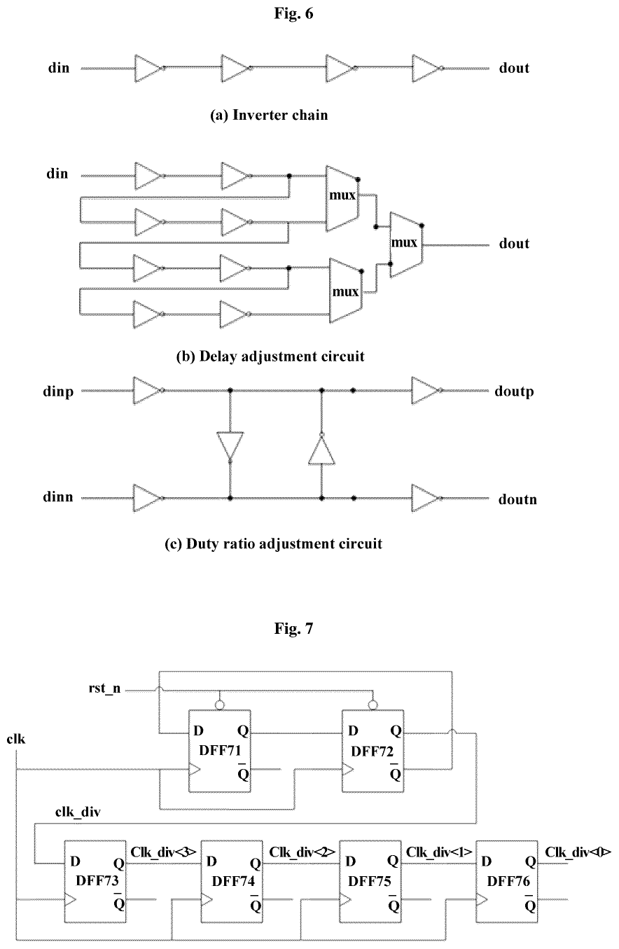

In at least one embodiment of the present disclosure, the buffers for the synchronization reference signal and the local clock signal have multiple variations. FIG. 6 is a circuit diagram of a buffer according to at least one embodiment of the present disclosure. As shown in FIG. 6, the buffer may be a simple chain of inverters (FIG. 6a) to increase driving capability; or the buffer may also integrate delay adjustment functions (FIG. 6b, by selecting different delay paths through a multiplexer to adjust the delay from input to output) to obtain a relatively stable timing relationship between data and clock; or the buffer may also integrate duty cycle adjustment functions (FIG. 6c, by inserting bidirectional inverters between the differential signal transmission paths to form positive feedback and optimize duty cycle) to ensure that the signal has accurate duty cycle information, etc.

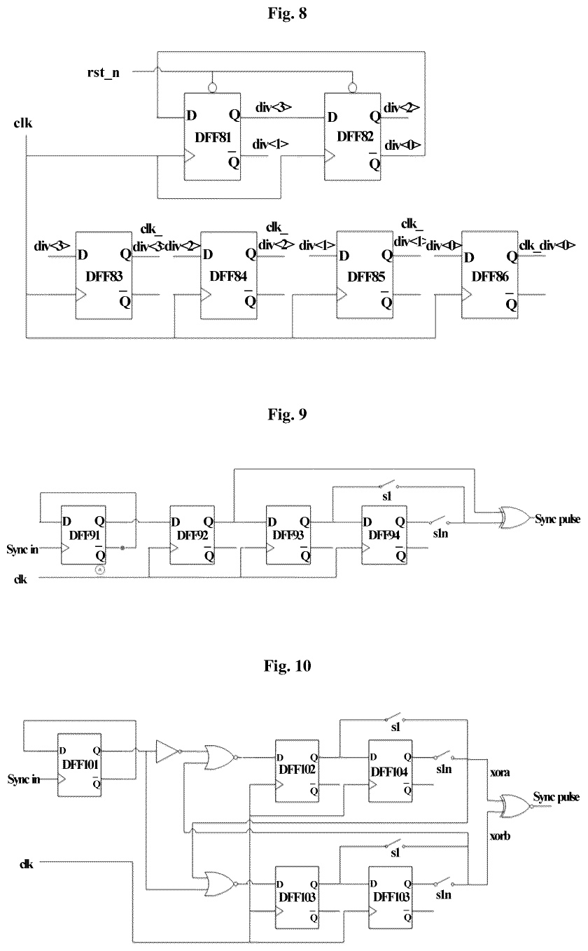

There are multiple variations in the multi-phase clock generation circuit, which can employ the Divider and the Shift register shown in FIG. 4. FIG. 7 is a first circuit diagram of multi-phase clock generation according to at least one embodiment of the present disclosure. As shown in FIG. 7, when rst_n is at a low level, DFF71-72 are reset, and clk_div outputs a low level. After rst_n is released, at the first clk rising edge, DFF1 output changes from a low level to a high level, while DFF72 output remains a low level. At the second clk rising edge, DFF1 output remains a high level, and DFF72 output, which is clk_div, changes from a low level to a high level. Following this rule, a 4-divided clock signal clk_div is generated. Subsequently, a 4-phase 4-divided clock signal clk_div<3:0> is generated from the clk_div through DFF 73-DFF76. FIG. 8 is a second circuit diagram of multi-phase clock generation according to at least one embodiment of the present disclosure. As shown in FIG. 8, the multi-phase clock is generated using a state machine and output synchronization. When rst_n is at a low level, DFF81-82 are reset, and div<3:0> outputs a low level. After rst_n is released, at the first clk rising edge, DFF1 output div<3> changes from a low level to a high level, and its inverse signal div<1> changes from a high level to a low level, and DFF82 output remains a low level. At the second clk rising edge, DFF1 output remains a high level, and DFF82 output, which is div<2>, changes from a low level to a high level, and its inverse signal div<1> changes from a high level to a low level. The output clk_div<3:0> is generated from the multi-phase divided signals div<3:0> after synchronization based on the clk through DFF83-DFF86.

The reset pulse signal generation circuit may have multiple variations. In the embodiment of this disclosure, to shield the falling edge of the synchronization reference signal, a rising edge-triggered circuit is integrated into the solution. FIG. 9 is a first circuit diagram of reset pulse generation according to at least one embodiment of the present disclosure. FIG. 10 is a second circuit diagram of reset pulse generation according to at least one embodiment of the present disclosure. As shown in FIG. 9 and FIG. 10, DFF91 is rising edge-triggered, so the output of DFF91 will only change when the rising edge of Sync in arrives. If dual edge-triggered is required, the rising edge-triggered circuit may be removed. In FIG. 9, the output signal of DFF91 produces signals with different delays (each passing through one DFF to be delayed by one clock cycle of the clk) under the control of clk through DFF92-94. When s1 is at a high level and sin is at a low level, the outputs of DFF92 and DFF93 pass through an XOR gate to generate a pulse signal of one clk cycle. When s1 is at a low level and sin is at a high level, a pulse signal of two clk cycles is generated. With the addition of more DFFs, a signal with a larger pulse width can also be generated. In FIG. 10, using the principle of generating two-phase non-overlapping signals, signals of different pulse widths are generated by adjusting the non-overlapping time through DFFs. When s1 is at a high level and sin is at a low level, DFF102 and DFF103 are connected to the inputs of an XOR gate. Since the signal of DFF103 is produced by the signal of DFF102 through one XOR gate and one DFF, a pulse signal with a delay of one DFF and one XOR gate is generated. When s1 is at a high level and sin is at a low level, DFF104 and DFF105 are connected to the inputs of the XOR gate. Since the signal of DFF105 is produced by the signal of DFF104 through one XOR gate and two DFFs, a pulse signal with a delay of two DFFs and one XOR gate is generated. With the addition of more DFFs, signals with a larger pulse width can also be produced.

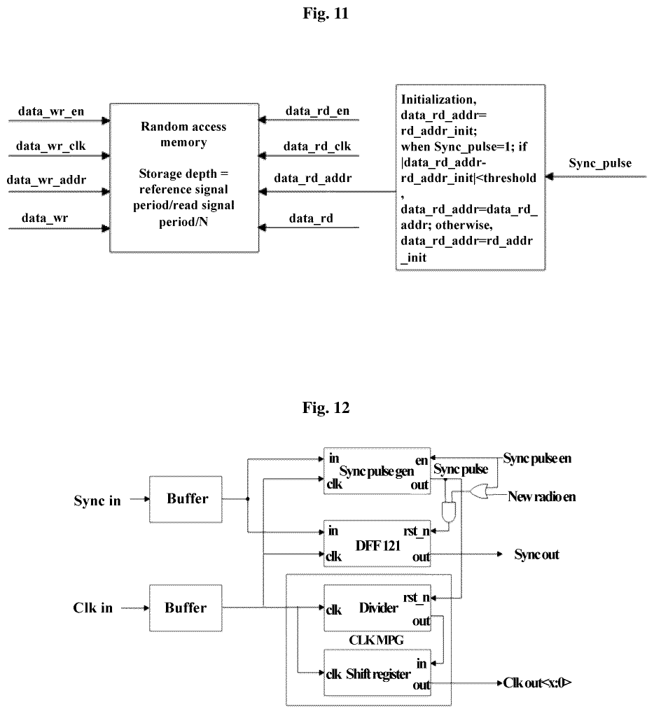

As shown in FIG. 3, after the system is powered on, a synchronization reference signal (Sync in1) is generated. As the synchronization reference signal passes through different clock domains (Clk domain1/2), the synchronization reference signal sequentially triggers the generation of local reset pulse signals (Sync pulse1/2), which are used for synchronizing and resetting the clock signals (Clk out1/2) and the output synchronization reference signals (Sync out1/2) in respective clock domains, thereby giving each clock signal (Clk out1/2) clear phase information. FIG. 11 is a second schematic diagram of clock frequency deviation compensation according to at least one embodiment of the present disclosure. As shown in FIG. 11, after the clock domain where a random access memory is located generates a clock signal (data_rd_clk) and a synchronization reset signal (Sync pulse), the read address (data_rd_addr) of the random access memory is initialized, and the read address is periodically checked. If the deviation of the read address exceeds a set threshold, the read address is reset to the initialization address (rd_addr_init); otherwise, the read address remains unchanged. Through the above process, precise timing delay of the data path is achieved.

The method of correcting clock frequency errors can take various forms. As shown in FIG. 11, to simplify the detection method of clock frequency, the storage depth of the memory should be ensured, such that the number of data read within the period of the synchronization reference is an integer multiple of the storage depth. In an ideal situation, when the rising edge of the synchronization reference signal (Sync pulse) arrives, the address (data_rd_addr) of the read data should always be the initialization address (rd_addr_init). By comparing the current address at the arrival of the rising edge of the synchronization reference signal with the initialization address, the error in the clock frequency can be determined. Then, the position of the read address in the data buffer is adjusted to compensate for the impact of clock frequency errors on delay precision.

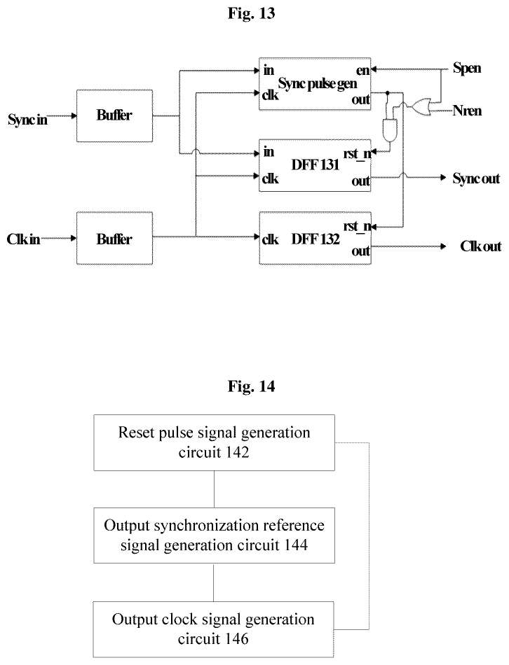

For the synchronization method of the output clock signal and the output synchronization reference signal (Sync out and Clk out), as shown in FIG. 4, the output synchronization reference signal is synchronized with the output multi-phase clock to generate a multi-phase synchronization reference signal. FIG. 12 is a second circuit diagram of high-precision time delay according to at least one embodiment of the present disclosure. As shown in FIG. 12, the output synchronization reference signal generation circuit is DFF121 (corresponding to the aforementioned DFF41), and the output clock signal generation circuit includes a Divider and a Shift register (similar to the aforementioned FIG. 4), whose signals are not synchronized and are output directly. FIG. 13 is a third circuit diagram of high-precision time delay according to at least one embodiment of the present disclosure. As shown in FIG. 13, the output synchronization reference signal generation circuit is DFF131 (corresponding to the aforementioned DFF41). If the output clock frequency is consistent with the input clock frequency, the multi-phase clock generation circuit may be replaced with a single-phase clock generation circuit, wherein the single-phase clock generation circuit includes DFF132 (corresponding to the aforementioned third DFF).

The embodiments of the present disclosure introduce a synchronization reference signal, use synchronous sequential logic, and transmit the synchronization reference signal together with the clock signal to different clock domains sequentially. By generating reset pulses locally in each clock domain for clock reset, the uncertainty of reset signal delay can be reduced. By using synchronous sequential logic, the synchronized signals are ensured to have clear time delay information, avoiding misalignment or metastability issues. Through the above method, stable and precise clock phases can be achieved.

By taking the period of the synchronization reference signal as a reference, the precision of the clock frequency is detected. Further, the position of the read address of the random access memory may be adjusted to adjust the time delay, thereby compensating for the time delay deviation introduced by the clock frequency deviation. This method is not found in traditional solutions.

According to another embodiment of the present disclosure, an apparatus for providing a clock signal in a data path is also provided. FIG. 14 is a block diagram of an apparatus for providing a clock signal in a data path according to at least one embodiment of the present disclosure. As shown in FIG. 14, the apparatus includes: a reset pulse signal generation circuit 142, an output synchronization reference signal generation circuit 144 and an output clock signal generation circuit 146.

The reset pulse signal generation circuit 142 is used, in each clock domain of a plurality of clock domains of the data path, for generating a reset pulse signal based on an input synchronization reference signal and an input clock signal, generating an output synchronization reference signal based on the input synchronization reference signal and the input clock signal, and generating an output clock signal based on the input clock signal. The reset pulse signal generation circuit 142 is used for inputting the reset pulse signal to the output synchronization reference signal generation circuit 144 and the output clock signal generation circuit 146, so as to reset the output synchronization reference signal and the output clock signal.

The output synchronization reference signal generation circuit 144 is used for synchronously generating a post-reset output synchronization reference signal at a next rising edge of the input clock signal after the reset pulse signal ends.

The output clock signal generation circuit 146 is used for synchronously generating a post-reset output clock signal at the next rising edge of the input clock signal after the reset pulse signal ends, wherein the post-reset output synchronization reference signal and the post-reset output clock signal are transmitted to a next clock domain of the data path with a same time delay, as the input synchronization reference signal and the input clock signal for the next clock domain.

In an embodiment, the reset pulse signal generation circuit 142 is further used for generating the reset pulse signal when a rising edge of the input synchronization reference signal is detected at a rising edge of the input clock signal.

In an embodiment, the output synchronization reference signal generation circuit 144 is further used for converting the output synchronization reference signal from a high level to a low level based on the reset pulse signal, and converting the output clock signal from a high level to a low level based on the reset pulse signal, so as to reset the output synchronization reference signal and the output clock signal.

In an embodiment, the output synchronization reference signal generation circuit 144 includes a first D type Flip-Flop (DFF), and the output clock signal generation circuit 146 is a single-phase clock generation circuit or a multi-phase clock generation circuit. The reset pulse signal generation circuit 142 is connected to the first DFF, and the reset pulse signal generation circuit 142 is connected to the single-phase clock generation circuit, alternatively, the reset pulse signal generation circuit 142 is connected to the multi-phase clock generation circuit.

The reset pulse signal generation circuit 142 is used for generating the reset pulse signal based on the input synchronization reference signal and the input clock signal, and inputting the reset pulse signal into the first DFF and the single-phase clock generation circuit or inputting the reset pulse signal into the first DFF and the multi-phase clock generation circuit.

The first DFF is used for synchronously generating the post-reset output synchronization reference signal based on the reset pulse signal, the input synchronization reference signal and the input clock signal at the next rising edge of the input clock signal after the reset pulse signal ends.

The single-phase clock generation circuit is used for synchronously generating a single-phase post-reset output clock signal based on the reset pulse signal and the input clock signal at the next rising edge of the input clock signal after the reset pulse signal ends, or

The multi-phase clock generation circuit is used for generating a multi-phase post-reset output clock signal based on the reset pulse signal and the input clock signal at the next rising edge of the input clock signal after the reset pulse signal ends.

In an embodiment, the output synchronization reference signal generation circuit 144 includes a first DFF and a second DFF, the first DFF is connected to the second DFF, the output clock signal generation circuit 146 is a multi-phase clock generation circuit or a single-phase clock generation circuit, the reset pulse signal generation circuit 142 is connected to the first DFF, and the reset pulse signal generation circuit 142 is connected to the single-phase clock generation circuit, alternatively, the reset pulse signal generation circuit 142 is connected to the multi-phase clock generation circuit,

The reset pulse signal generation circuit 142 is used for generating the reset pulse signal based on the input synchronization reference signal and the input clock signal, and inputting the reset pulse signal into the first DFF and the single-phase clock generation circuit or inputting the reset pulse signal into the first DFF and the multi-phase clock generation circuit.

The first DFF is used for generating the post-reset output synchronization reference signal based on the reset pulse signal, the input synchronization reference signal and the input clock signal at the next rising edge of the input clock signal after the reset pulse signal ends, and inputting the post-reset output synchronization reference signal to the second DFF.

The second DFF is used for synchronizing the post-reset output synchronization reference signal according to the post-reset output clock signal to obtain a new post-reset output synchronization reference signal.

The single-phase clock generation circuit is used for synchronously generating a single-phase post-reset output clock signal based on the reset pulse signal and the input clock signal at the next rising edge of the input clock signal after the reset pulse signal ends; or

The multi-phase clock generation circuit is used for synchronously generating a multi-phase post-reset output clock signal based on the reset pulse signal and the input clock signal at the next rising edge of the input clock signal after the reset pulse signal ends.

In an embodiment, the single-phase clock generation circuit includes a third DFF, wherein the third DFF is used for synchronously generating the single-phase post-reset output clock signal based on the reset pulse signal and the input clock signal at the next rising edge of the input clock signal after the reset pulse signal ends.

The multi-phase clock generation circuit includes a Divider and a Shift register, wherein the reset pulse signal generation circuit is connected to the Divider, and the Divider is connected to the Shift register.

The Divider is used for generating a single-phase divided clock based on the reset pulse signal and the input clock signal at the next rising edge of the input clock signal after the reset pulse signal ends.

The Shift register is used for generating the multi-phase post-reset output clock signal according to the input clock signal under control of the single-phase divided clock.

In an embodiment, the single-phase clock generation circuit includes a third DFF, wherein the third DFF is used for synchronously generating the single-phase post-reset output clock signal based on the reset pulse signal and the input clock signal at the next rising edge of the input clock signal after the reset pulse signal ends.

The multi-phase clock generation circuit includes a state machine and a synchronization circuit, wherein the reset pulse signal generation circuit 142 is connected to the state machine, and the state machine is connected to the synchronization circuit.

The state machine is used for generating a multi-phase divided clock according to the reset pulse signal and the input clock signal at the next rising edge of the input clock signal after the reset pulse signal ends.

The synchronization circuit is used for synchronizing the multi-phase divided clock, and outputting the multi-phase post-reset output clock signal.

In an embodiment, the apparatus further includes a first buffer and a second buffer, wherein the first buffer is connected to the reset pulse signal generation circuit 142 and the output synchronization reference signal generation circuit 144 respectively, and the second buffer is connected to the reset pulse signal generation circuit 142, the output synchronization reference signal generation circuit 144 and the output clock signal generation circuit 146 respectively.

The input synchronization reference signal enters the reset pulse signal generation circuit 142 and the output synchronization reference signal generation circuit 144 respectively through the first buffer.

The input clock signal enters the reset pulse signal generation circuit 142, the output synchronization reference signal generation circuit 144 and the output clock signal generation circuit 14 respectively through the second buffer.

In an embodiment, the first buffer and the second buffer are structured as a chain of inverters, or the first buffer and the second buffer are integrated with a delay adjustment circuit, or the first buffer and the second buffer are integrated with a duty cycle adjustment circuit.

In an embodiment, the reset pulse signal generation circuit is further used for generating the reset pulse signal based on the input synchronization reference signal and the input clock signal in a case where a reset pulse enable signal is enabled and a new radio enable signal is enabled, and in a case where the reset pulse enable signal is enabled and the new radio enable signal is enabled, resetting the output synchronization reference signal and the output clock signal by the reset pulse signal, and synchronously generating the post-reset output synchronization reference signal and the post-reset output clock signal at the next rising edge of the input clock signal after the reset pulse

In an embodiment, the reset pulse signal generation circuit is further used for not resetting the output synchronization reference signal and the output clock signal in a case where the reset pulse enable signal is enabled and the new radio enable signal is not enabled; the reset pulse signal generation circuit is further used for not resetting the post-reset output synchronization reference signal and the post-reset output clock signal in a case where the reset pulse enable signal is not enabled and the new radio enable signal is enabled.

In an embodiment, the reset pulse signal generation circuit 142 is further used for generating, by using a reset pulse generation mode of a delayed signal, the reset pulse signal based on the input synchronization reference signal and the input clock signal; or generating, by using a reset pulse generation mode of a two-phase non-overlapping signal, the reset pulse signal based on the input synchronization reference signal and the input clock signal.

In an embodiment, the apparatus further includes a compensation circuit.

The compensation circuit is used for counting the input clock signal in a period of the input synchronization reference signal of the plurality of clock domains, so as to obtain a counting result, comparing the counting result with a preset counting result to obtain a first comparison result, determining a first clock frequency deviation of a target time delay according to the first comparison result, and adjusting a time delay of the data path by adjusting an address of read data, so as to compensate for the first clock frequency deviation of the target time delay; or acquiring a current address upon arrival of a rising edge of the input synchronization reference signal, comparing the current address with an initialization address to obtain a second comparison result, determining a second clock frequency deviation of a target time delay according to the second comparison result, adjusting a time delay of the data path by adjusting a position of a read address in a random access memory, so as to compensate for the second clock frequency deviation of the target time delay, wherein the target time delay is a time from a start of resetting the output synchronization reference signal and the output clock signal to the synchronously generating the post-reset output synchronization reference signal and the post-reset output clock signal, and a storage depth of the random access memory is a product of a ratio of a period of the input synchronization reference signal to a period of a read signal, and an inverse of N.

The embodiments of the present disclosure also provide a computer readable storage medium. The computer readable storage medium stores a computer program, and the computer program, when running on a processor, causes the processor to execute the operations in any one of the described method embodiments.

In an exemplary embodiment, the computer readable storage medium may include, but is not limited to, any medium that can store a computer program, such as a Universal Serial Bus (USB) flash drive, a Read-Only Memory (ROM), a Random access memory (RAM), a removable hard disk, a magnetic disk, or an optical disc.

The embodiments of the present disclosure further provide an electronic device, including a memory and a processor, wherein the memory stores a computer program, and the processor is configured to run the computer program so as to execute operations in any one of the method embodiments.

In an exemplary embodiment, the electronic device may further include a transmission device and an input/output device, wherein the transmission device is connected to the processor, and the input/output device is connected to the processor.

For specific embodiments in this embodiment, reference may be made to the embodiments described in the foregoing embodiments and exemplary embodiments, and details are not repeatedly described in this embodiment.

Obviously, those having ordinary skill in the art should understand that each module or each operation of the present disclosure can be implemented by a universal computing device, they may be centralized on a single computing device or distributed on a network composed of a plurality of computing devices, they can be implemented by program codes executable by a computing device, and thus can be stored in a storage apparatus and executed by the computing device. Furthermore, in some cases, the shown or described operations may be executed in an order different from that described here, or they are made into integrated circuit modules respectively, or a plurality of modules or operations therein are made into a single integrated circuit module for implementation. As such, the present disclosure is not limited to any particular hardware and software combination.

The foregoing descriptions are merely exemplary embodiments of the present disclosure, but are not intended to limit the present disclosure. For those having ordinary skill in the art, the present disclosure may have various modifications and variations. Any modifications, equivalent replacements, improvements and the like made within the principle of the present disclosure shall fall within the scope of protection of the present disclosure.

1. A method for providing a clock signal in a data path, comprising:
in each clock domain of a plurality of clock domains of the data path, generating a reset pulse signal based on an input synchronization reference signal and an input clock signal, generating an output synchronization reference signal based on the input synchronization reference signal and the input clock signal, and generating an output clock signal based on the input clock signal; and
resetting the output synchronization reference signal and the output clock signal by the reset pulse signal, and synchronously generating a post-reset output synchronization reference signal and a post-reset output clock signal at a next rising edge of the input clock signal after the reset pulse signal ends, wherein the post-reset output synchronization reference signal and the post-reset output clock signal are transmitted to a next clock domain of the data path with a same time delay, as the input synchronization reference signal and the input clock signal for the next clock domain.

2. The method according to claim 1, wherein generating the reset pulse signal based on the input synchronization reference signal and the input clock signal comprises:
generating the reset pulse signal when a rising edge of the input synchronization reference signal is detected at a rising edge of the input clock signal.

3. The method according to claim 1, wherein resetting the output synchronization reference signal and the output clock signal by the reset pulse signal comprises:
converting the output synchronization reference signal from a high level to a low level based on the reset pulse signal, and converting the output clock signal from a high level to a low level based on the reset pulse signal, so as to reset the output synchronization reference signal and the output clock signal.

4. The method according to claim 1, wherein generating the post-reset output clock signal comprises:
generating a single-phase post-reset output clock signal according to the reset pulse signal and the input clock signal; or
generating a multi-phase post-reset output clock signal according to the reset pulse signal and the input clock signal.

5. The method according to claim 4, wherein after generating the post-reset output synchronization reference signal and the post-reset output clock signal, the method further comprises:
synchronizing the post-reset output synchronization reference signal according to the post-reset output clock signal to obtain a new post-reset output synchronization reference signal.

6. The method according to claim 4, wherein generating the multi-phase post-reset output clock signal according to the reset pulse signal and the input clock signal comprises:
generating a single-phase divided clock according to the input clock signal and the reset pulse signal, and generating the multi-phase post-reset output clock signal according to the single-phase divided clock under control of the input clock signal; or
generating a multi-phase divided clock according to the input clock signal and the reset pulse signal, synchronizing the multi-phase divided clock, and outputting the multi-phase post-reset output clock signal.

7. (canceled)

8. The method according to claim 1, wherein
generating the reset pulse signal based on the input synchronization reference signal and the input clock signal comprises: in a case where a reset pulse enable signal is enabled and a new radio enable signal is enabled, generating the reset pulse signal based on the input synchronization reference signal and the input clock signal; and
resetting the output synchronization reference signal and the output clock signal by the reset pulse signal, and synchronously generating the post-reset output synchronization reference signal and the post-reset output clock signal at the next rising edge of the input clock signal after the reset pulse signal ends comprises: in a case where the reset pulse enable signal is enabled and the new radio enable signal is enabled, resetting the output synchronization reference signal and the output clock signal by the reset pulse signal, and synchronously generating the post-reset output synchronization reference signal and the post-reset output clock signal at the next rising edge of the input clock signal after the reset pulse signal ends.

9. The method according to claim 8, further comprising:
in a case where the reset pulse enable signal is enabled and the new radio enable signal is not enabled, not resetting the output synchronization reference signal and the output clock signal;
in a case where the reset pulse enable signal is not enabled and the new radio enable signal is enabled, not resetting the post-reset output synchronization reference signal and the post-reset output clock signal.

10. The method according to claim 1, further comprising:
counting the input clock signal in a period of the input synchronization reference signal of the plurality of clock domains, so as to obtain a counting result ; _ comparing the counting result with a preset counting result to obtain a first comparison result;
determining a first clock frequency deviation of a target time delay according to the first comparison result, wherein the target time delay is a time from a start of resetting the output synchronization reference signal and the output clock signal to the synchronously generating the post-reset output synchronization reference signal and the post-reset output clock signal; and
adjusting a time delay of the data path by adjusting an address of read data, so as to compensate for the first clock frequency deviation of the target time delay;
or,
acquiring a current address upon arrival of a rising edge of the input synchronization reference signal; comparing the current address with an initialization address to obtain a second comparison result; determining a second clock frequency deviation of a target time delay according to the second comparison result, wherein the target time delay is a time from a start of resetting the output synchronization reference signal and the output clock signal to the synchronously generating the post-reset output synchronization reference signal and the post-reset output clock signal; and adjusting a time delay of the data path by adjusting a position of a read address in a random access memory, so as to compensate for the second clock frequency deviation of the target time delay, wherein a storage depth of the random access memory is a product of a ratio of a period of the input synchronization reference signal to a period of a read signal, and an inverse of N.

11. (canceled)

12. An apparatus for providing a clock signal in a data path, comprising: a reset pulse signal generation circuit, an output synchronization reference signal generation circuit, and an output clock signal generation circuit, wherein
the reset pulse signal generation circuit is used, in each clock domain of a plurality of clock domains of the data path, for generating a reset pulse signal based on an input synchronization reference signal and an input clock signal, generating an output synchronization reference signal based on the input synchronization reference signal and the input clock signal, and generating an output clock signal based on the input clock signal; and
the reset pulse signal generation circuit is used for inputting the reset pulse signal to the output synchronization reference signal generation circuit and the output clock signal generation circuit, so as to reset the output synchronization reference signal and the output clock signal;
the output synchronization reference signal generation circuit is used for synchronously generating a post-reset output synchronization reference signal at a next rising edge of the input clock signal after the reset pulse signal ends; and
the output clock signal generation circuit is used for synchronously generating a post-reset output clock signal at the next rising edge of the input clock signal after the reset pulse signal ends, wherein the post-reset output synchronization reference signal and the post-reset output clock signal are transmitted to a next clock domain of the data path with a same time delay, as the input synchronization reference signal and the input clock signal for the next clock domain.

13. The apparatus according to claim 12, wherein
the reset pulse signal generation circuit is further used for generating the reset pulse signal when a rising edge of the input synchronization reference signal is detected at a rising edge of the input clock signal.

14. The apparatus according to claim 12, wherein
the output synchronization reference signal generation circuit is further used for converting the output synchronization reference signal from a high level to a low level based on the reset pulse signal, and converting the output clock signal from a high level to a low level based on the reset pulse signal, so as to reset the output synchronization reference signal and the output clock signal.

15. The apparatus according to claim 12, wherein
the output synchronization reference signal generation circuit comprises a first D type Flip-Flop (DFF), and the output clock signal generation circuit is a single-phase clock generation circuit or a multi-phase clock generation circuit, wherein the reset pulse signal generation circuit is connected to the first DFF, and the reset pulse signal generation circuit is connected to the single-phase clock generation circuit or the multi-phase clock generation circuit, wherein
the reset pulse signal generation circuit is used for generating the reset pulse signal based on the input synchronization reference signal and the input clock signal, and inputting the reset pulse signal into the first DFF and the single-phase clock generation circuit or inputting the reset pulse signal into the first DFF and the multi-phase clock generation circuit ; _
the first DFF is used for synchronously generating the post-reset output synchronization reference signal based on the reset pulse signal, the input synchronization reference signal and the input clock signal at the next rising edge of the input clock signal after the reset pulse signal ends; and
the single-phase clock generation circuit is used for synchronously generating a single-phase post-reset output clock signal based on the reset pulse signal and the input clock signal at the next rising edge of the input clock signal after the reset pulse signal ends, or_
the multi-phase clock generation circuit is used for generating a multi-phase post-reset output clock signal based on the reset pulse signal and the input clock signal at the next rising edge of the input clock signal after the reset pulse signal ends;
or,
the output synchronization reference signal generation circuit comprises a first D type Flip-Flop (DFF) and a second DFF, the first DFF is connected to the second DFF, the output clock signal generation circuit is a multi-phase clock generation circuit or a single-phase clock generation circuit, the reset pulse signal generation circuit is connected to the first DFF, and the reset pulse signal generation circuit is connected to the single-phase clock generation circuit or the multi-phase clock generation circuit, wherein the reset pulse signal generation circuit is used for generating the reset pulse signal based on the input synchronization reference signal and the input clock signal, and inputting the reset pulse signal into the first DFF and the single-phase clock generation circuit or inputting the reset pulse signal into the first DFF and the multi-phase clock generation circuit; the first DFF is used for generating the post-reset output synchronization reference signal based on the reset pulse signal, the input synchronization reference signal and the input clock signal at the next rising edge of the input clock signal after the reset pulse signal ends, and inputting the post-reset output synchronization reference signal to the second DFF; the second DFF is used for synchronizing the post-reset output synchronization reference signal according to the post-reset output clock signal to obtain a new post-reset output synchronization reference signal; and the single-phase clock generation circuit is used for synchronously generating a single-phase post-reset output clock signal based on the reset pulse signal and the input clock signal at the next rising edge of the input clock signal after the reset pulse signal ends, or the multi-phase clock generation circuit is used for synchronously generating a multi-phase post-reset output clock signal based on the reset pulse signal and the input clock signal at the next rising edge of the input clock signal after the reset pulse signal ends.

16. (canceled)

17. The apparatus according to claim 15, wherein
the single-phase clock generation circuit comprises a third DFF, wherein the third DFF is used for synchronously generating the single-phase post-reset output clock signal based on the reset pulse signal and the input clock signal at the next rising edge of the input clock signal after the reset pulse signal ends;
the multi-phase clock generation circuit comprises a Divider and a Shift register, wherein the reset pulse signal generation circuit is connected to the Divider, and the Divider is connected to the Shift register, wherein
the Divider is used for generating a single-phase divided clock based on the reset pulse signal and the input clock signal at the next rising edge of the input clock signal after the reset pulse signal ends;
the Shift register is used for generating the multi-phase post-reset output clock signal according to the input clock signal under control of the single-phase divided clock;
or,
the single-phase clock generation circuit comprises a third DFF, wherein the third DFF is used for synchronously generating the single-phase post-reset output clock signal based on the reset pulse signal and the input clock signal at the next rising edge of the input clock signal after the reset pulse signal ends; the multi-phase clock generation circuit comprises a state machine and a synchronization circuit, wherein the reset pulse signal generation circuit is connected to the state machine, and the state machine is connected to the synchronization circuit, wherein the state machine is used for generating a multi-phase divided clock according to the reset pulse signal and the input clock signal at the next rising edge of the input clock signal after the reset pulse signal ends; and the synchronization circuit is used for synchronizing the multi-phase divided clock, and outputting the multi-phase post-reset output clock signal.

18. (canceled)

19. The apparatus according to claim 12, further comprising a first buffer and a second buffer, wherein the first buffer is connected to the reset pulse signal generation circuit and the output synchronization reference signal generation circuit, respectively, and the second buffer is connected to the reset pulse signal generation circuit, the output synchronization reference signal generation circuit and the output clock signal generation circuit, respectively, wherein
the input synchronization reference signal enters the reset pulse signal generation circuit and the output synchronization reference signal generation circuit respectively through the first buffer; and
the input clock signal enters the reset pulse signal generation circuit, the output synchronization reference signal generation circuit and the output clock signal generation circuit respectively through the second buffer.

20. The apparatus according to claim 19, wherein
the first buffer and the second buffer are structured as a chain of inverters, or the first buffer and the second buffer are integrated with a delay adjustment circuit, or the first buffer and the second buffer are integrated with a duty cycle adjustment circuit.

21. The apparatus according to claim 12any wherein
the reset pulse signal generation circuit is further used for generating the reset pulse signal based on the input synchronization reference signal and the input clock signal in a case where a reset pulse enable signal is enabled and a new radio enable signal is enabled, and in a case where the reset pulse enable signal is enabled and the new radio enable signal is enabled, resetting the output synchronization reference signal and the output clock signal by the reset pulse signal, and synchronously generating the post-reset output synchronization reference signal and the post-reset output clock signal at the next rising edge of the input clock signal after the reset pulse signal ends.

22. The apparatus according to claim 21, wherein
the reset pulse signal generation circuit is further used for not resetting the output synchronization reference signal and the output clock signal in a case where the reset pulse enable signal is enabled and the new radio enable signal is not enabled; the reset pulse signal generation circuit is further used for not resetting the post-reset output synchronization reference signal and the post-reset output clock signal in a case where the reset pulse enable signal is not enabled and the new radio enable signal is enabled.

23. The apparatus according to claim 12, wherein
the reset pulse signal generation circuit is further used for generating, by using a reset pulse generation mode of a delayed signal, the reset pulse signal based on the input synchronization reference signal and the input clock signal; or generating, by using a reset pulse generation mode of a two-phase non-overlapping signal, the reset pulse signal based on the input synchronization reference signal and the input clock signal.

24. The apparatus according to claim 12, further comprising a compensation circuit, wherein
the compensation circuit is used for counting the input clock signal in a period of the input synchronization reference signal of the plurality of clock domains, so as to obtain a counting result, comparing the counting result with a preset counting result to obtain a first comparison result, determining a first clock frequency deviation of a target time delay according to the first comparison result, and adjusting a time delay of the data path by adjusting an address of read data, so as to compensate for the first clock frequency deviation of the target time delay; or acquiring a current address upon arrival of a rising edge of the input synchronization reference signal, comparing the current address with an initialization address to obtain a second comparison result, determining a second clock frequency deviation of a target time delay according to the second comparison result, adjusting a time delay of the data path by adjusting a position of a read address in a random access memory, so as to compensate for the second clock frequency deviation of the target time delay, wherein the target time delay is a time from a start of resetting the output synchronization reference signal and the output clock signal to the synchronously generating the post-reset output synchronization reference signal and the post-reset output clock signal, and a storage depth of the random access memory is a product of a ratio of a period of the input synchronization reference signal to a period of a read signal, and an inverse of N.

25. (canceled)

26. (canceled)
